(19) United States
(12) Patent Application Publication
(10) Pub. No.: US 2023/0166713 A1
(43) Pub. Date: Jun. 1, 2023

(54) STRADDLE TYPE VEHICLE, METHOD FOR CONTROLLING VEHICLE, AND NON-TRANSITORY COMPUTER READABLE STORAGE MEDIUM

(71) Applicant: KAWASAKI MOTORS, LTD., Hyogo (JP)

(72) Inventor: Kosuke OBAYASHI, Hyogo (JP)

(21) Appl. No.: 17/989,322

(22) Filed: Nov. 17, 2022

(30) Foreign Application Priority Data
Nov. 19, 2021 (JP) 2021-188372

(51) Int. Cl. B60W 20/10; B62J 45/20; B62J 45/415; B60W 10/06; B60W 10/08

(52) U.S. Cl. CPC B60W 20/10; B62J 45/20; B62J 45/415; B60W 10/06; B60W 10/08; B60W 2300/36; B60W 2710/0666; B60W 2710/083; B60W 2520/18; B60W 2520/28

(57) ABSTRACT

There is provided a straddle type vehicle including a processing circuit. The processing circuit is configured to: change, upon receiving a boost signal from a boost input device, a target torque from a normal torque to a boost torque obtained by adding a predetermined boost amount to the normal torque; and correct, upon receiving a predetermined inclination signal from the posture detector, the target torque such that a torque change of the drive wheel when the target torque is changed from the normal torque to the boost torque is decreased as compared with a case where the inclination signal is not received.

### TECHNICAL FIELD

The present disclosure relates to a straddle type vehicle having a normal mode of traveling while setting a target torque to a normal torque and a boost mode of traveling while setting the target torque to a boost torque larger than the normal torque, a method for controlling a vehicle, and a non-transitory computer readable storage medium storing a control program.

### BACKGROUND ART

JP2020-158061A discloses a straddle type vehicle in which a boost mode of adding a predetermined boost drive force to a drive force during traveling is set.

Vehicles are assumed to be in various traveling states.

Therefore, it is desirable that the boost drive force be set to a value suitable for the vehicle.

### SUMMARY OF INVENTION

An aspect of the present disclosure provides a straddle type vehicle in which a suitable boost torque is set for each traveling state and a boost drive force is set corresponding to the situation, a method for controlling a vehicle, and a non-transitory computer readable storage medium storing a control program.

According to an aspect of the present disclosure, a straddle type vehicle includes: a drive wheel; a vehicle body supported by the drive wheel; at least one traveling drive source configured to generate a torque to be transmitted to the drive wheel; a posture detector configured to detect a posture of the vehicle body; a boost input device configured to accept a boost command; and a processing circuit configured to control the at least one traveling drive source. The processing circuit is configured to: determine a target torque of the traveling drive source as a normal torque in accordance with a predetermined travel rule when the boost command is not given to the boost input device, change, upon receiving a boost signal from a boost input device, a target torque from a normal torque to a boost torque obtained by adding a predetermined boost amount to the normal torque, and correct, upon receiving a predetermined inclination signal from the posture detector, the target torque such that a torque change of the drive wheel when the target torque is changed from the normal torque to the boost torque is decreased as compared with a case where the inclination signal is not received.

According to another aspect of the present disclosure, there is provided a method for controlling a vehicle including: a drive wheel; a vehicle body supported by the drive wheel; at least one traveling drive source configured to generate a torque to be transmitted to the drive wheel; a detector configured to detect a value related to a tire force generated on a wheel with respect to a road surface during travel; and a boost input device configured to accept a boost command. The method includes: determining a target torque of the traveling drive source as a normal torque in accordance with a predetermined travel rule when the boost command is not given to the boost input device; changing, upon receiving a boost signal from the boost input device, the target torque from the normal torque to a boost torque obtained by adding a predetermined boost amount to the normal torque; and correcting, based on a value related to the tire force detected by the detector, the target torque when changing the target torque from the normal torque to the boost torque.

According to the above aspect, it is possible to a suitable boost torque for each traveling state and a boost drive force is set corresponding to the situation.

### BRIEF DESCRIPTION OF DRAWINGS

FIG. 1 is a side view of a straddle type vehicle according to a first embodiment.

FIG. 2 is a plan view of a handle of the straddle type vehicle of FIG. 1.

FIG. 3 is a schematic view of a power system of the straddle type vehicle of FIG. 1.

FIG. 4 is a block diagram of a control system of the straddle type vehicle of FIG. 1.

FIG. 5 is a schematic view illustrating a bank angle and a tire force in the straddle type vehicle of FIG. 1.

FIG. 6 is an explanatory view illustrating a tire force acting on a tire of a rear wheel and a friction circle of the tire of the rear wheel when a vehicle body is inclined in a left-right direction in the straddle type vehicle of FIG. 1.

FIG. 7 is a graph illustrating the correlation between a torque and the time in comparison between the transition of a boost torque when not corrected and the transition of the boost torque when corrected upon the detection of the inclination of the vehicle body in the straddle type vehicle in FIG. 1.

FIG. 8 is a graph illustrating a correlation between a target torque and the time with respect to a driving torque of a rear wheel in the straddle type vehicle of FIG. 1.

FIG. 9 is a flowchart when torque control is performed in the straddle type vehicle in FIG. 1.

FIG. 10 is a graph illustrating the correlation between the torque and the time in comparison between the transition of the boost torque when not corrected and the transition of the boost torque when corrected upon the detection of the inclination of the vehicle body in a straddle type vehicle of a second embodiment.

FIG. 11 is a graph illustrating the correlation between the target torque and the time with respect to the driving torque of the rear wheel in the straddle type vehicle of the second embodiment.

FIG. 12 is a flowchart when torque control is performed in the straddle type vehicle of the second embodiment.

FIG. 13 is a graph illustrating the correlation between the torque and the time in comparison between the transition of the boost torque when not corrected and the transition of the boost torque when corrected upon the detection of the inclination of the vehicle body in a straddle type vehicle of a modification of the second embodiment.

### DESCRIPTION OF EMBODIMENTS

Hereinafter, a straddle type vehicle, a control method for vehicle, and a non-transitory computer readable storage medium storing a control program according to an embodiment will be described with reference to the accompanying drawings. In the present specification, a front-rear direction, a left-right direction (lateral direction), and an upper-lower direction indicate directions viewed from a rider when the rider is seated on the vehicle.

### First Embodiment

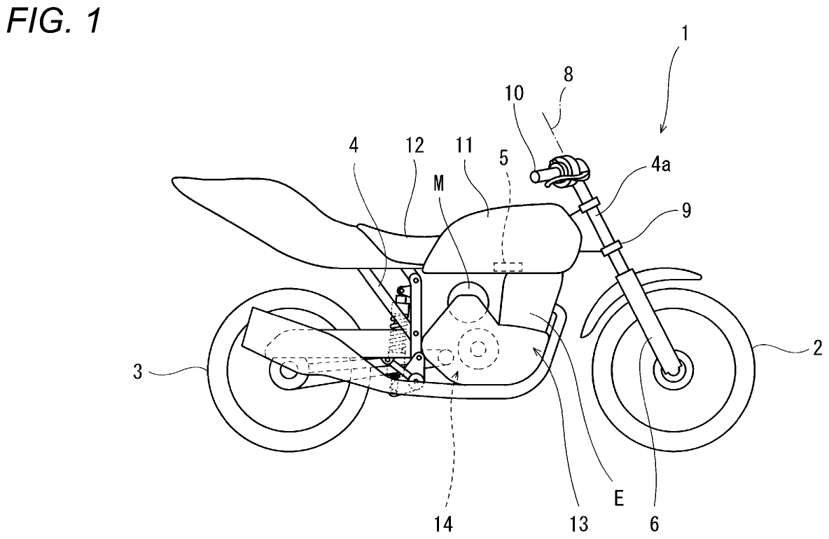

FIG. 1 is a side view of a straddle type vehicle 1 (vehicle) according to a first embodiment. As illustrated in FIG. 1, in the present embodiment, the straddle type vehicle 1 is a motorcycle as a hybrid vehicle.

The straddle type vehicle 1 includes a front wheel (driven wheel) 2, a rear wheel (drive wheel) 3, a vehicle body frame (vehicle body) 4, a front suspension 6 connecting the front wheel 2 to a front portion of the vehicle body frame 4, and a rear suspension 7 connecting the rear wheel 3 to a rear portion of the vehicle body frame 4. The vehicle body frame 4 is supported by the front wheel 2 and the rear wheel 3. The front suspension 6 is provided at a lower portion of a steering shaft 8, and is coupled to a bracket 9 disposed at an interval from the front suspension 6 in an upper-lower direction. The steering shaft 8 connected to the bracket 9 is supported by a head pipe 4a, which is a part of the vehicle body frame 4, to be angularly displaceable. The straddle type vehicle 1 includes a posture detector capable of detecting the posture of the straddle type vehicle 1. In the present embodiment, the gyroscope 5 is provided on the straddle type vehicle 1 as the posture detector.

The steering shaft 8 is provided with a handle 10 that is gripped by hands of the rider. A fuel tank 11 is provided at the rear side of the handle 10, and a seat 12 for the rider to be seated is provided at the rear side of the fuel tank 11. A power unit 13 serving as a traveling drive source is mounted on the vehicle body frame 4 between the front wheel 2 and the rear wheel 3.

The power unit 13 includes an engine E (first traveling drive source) that is an internal combustion engine as a prime mover, and a drive motor M (second traveling drive source) that has a drive shaft and is an electric motor as a prime mover. In the present embodiment, the engine E and the drive motor M have a function as a prime mover that generates a rotational drive force to be transmitted to the rear wheel 3. A transmission 14 is disposed in a power transmission path from the engine E to the rear wheel 3, which is the drive wheel. In the present embodiment, the transmission 14 is disposed on the rear side of the engine E.

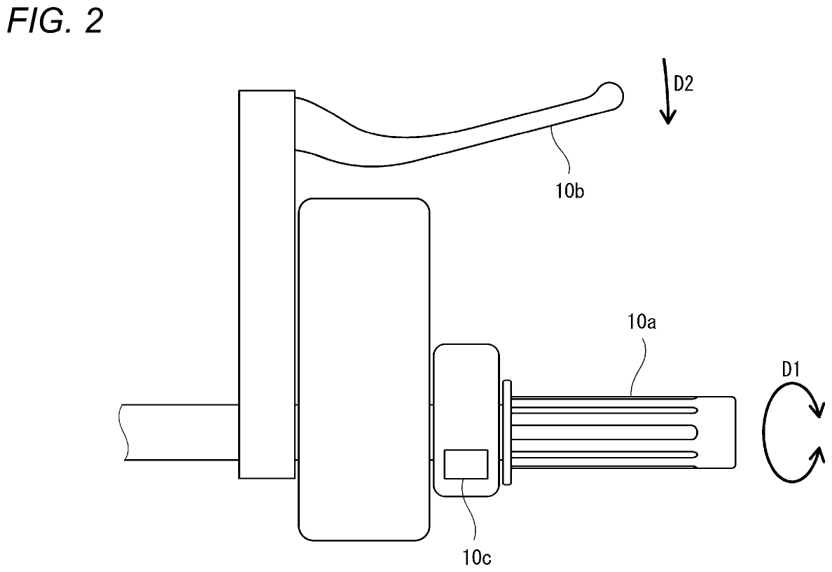

FIG. 2 is a plan view of the handle 10. The handle 10 includes an accelerator operator 10a that is operated by the rider to adjust acceleration and deceleration of the straddle type vehicle 1, a brake operator 10b that is operated by the rider to cause deceleration of the straddle type vehicle 1 and adjust the deceleration, and a boost input device 10c that is operated by the rider to apply a drive force to the rear wheel 3 of the straddle type vehicle 1. Acceleration and deceleration of the straddle type vehicle 1 is adjusted by the rider rotating the accelerator operator 10a in a direction D1. Deceleration of the straddle type vehicle 1 is caused by the rider moving the brake operator 10b by the rider in the direction D2. The degree of deceleration of the straddle type vehicle 1 is increased by the rider increasing the amount of movement thereof in the direction D2. The boost input device 10c is configured as a switch capable of receiving a boost command from the rider. When the rider presses the boost input device 10c so that the boost command is received by the boost input device 10c, the drive force can be applied to the rear wheel 3 of the straddle type vehicle 1. The application of the drive force to the rear wheel 3 may be continued for a certain period of time from when the rider presses the boost input device 10c, or may be performed only while the rider presses the boost input device 10c.

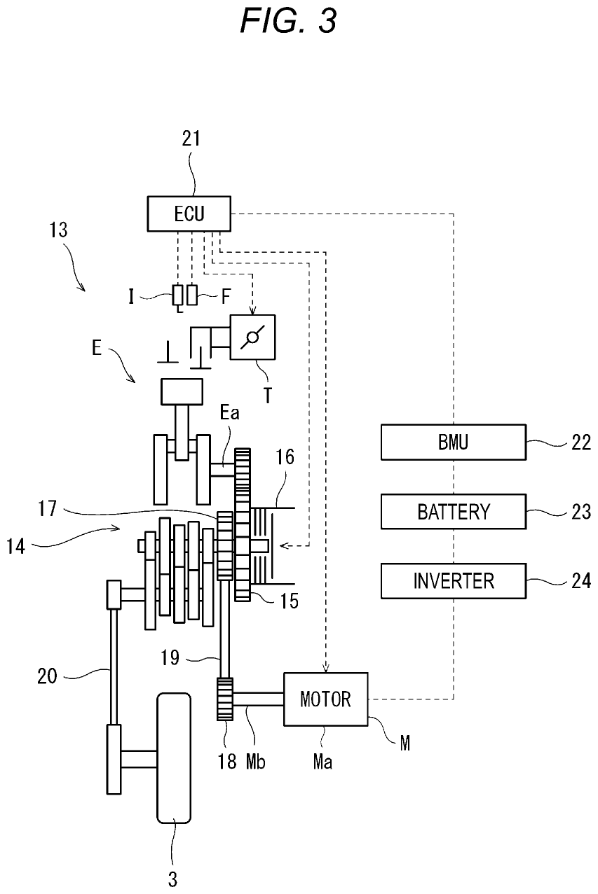

FIG. 3 is a schematic view of a power system of the straddle type vehicle 1 of FIG. 1. The transmission 14 includes an input shaft, an output shaft, and a plurality of gear trains having different reduction ratios. The transmission 14 is configured to transmit power from the input shaft to the output shaft via the gear trains, and selects one of the gear trains to change the speed. For example, the transmission 14 is a dog clutch type transmission. One end portion of a crankshaft Ea of the engine E is connected to a primary gear 15, so that power can be transmitted.

The primary gear 15 is provided in a manner of being rotatable relative to the transmission 14 around an axis of the transmission 14. The primary gear 15 is connected to the transmission 14 via a main clutch 16 so that power can be transmitted. The main clutch 16 disconnects or connects a power path from the crankshaft Ea to the transmission 14. The main clutch 16 is driven by hydraulic pressure to disconnect or connect the power path from the crankshaft Ea to the transmission 14.

A sprocket 17 is provided between the primary gear 15 and the transmission 14. The drive motor M includes a motor housing Ma and a motor drive shaft Mb protruding from the motor housing Ma, and a sprocket 18 is provided on the motor drive shaft Mb to rotate together with the motor drive shaft Mb. Instead of the sprockets 17 and 18, a gear or a pulley may be used as a rotating member. A chain 19 is connected to the sprocket 17 closer to the transmission 14 and the sprocket 18 closer to the motor drive shaft Mb. As a result, the drive force of the drive motor M is transmitted to the transmission 14 via the sprocket 17. The transmission 14 transmits the drive force to the rear wheel 3 via an output transmission member 20 (for example, a chain, a belt, or the like).

An ECU 21 (processing circuit) controls the engine E. Specifically, a throttle device T, a fuel injection device F, and an ignition device I are controlled. The ECU 21 controls connection and disconnection of the main clutch 16 as described above, and switches whether to transmit the drive force of the engine E to the rear wheel 3 as the drive wheel. The ECU 21 controls the driving of the drive motor M via a battery management unit (BMU) 22, a battery 23, and an inverter 24. The ECU 21 can switch whether to drive the rear wheel 3 by the engine E, by the drive motor M, or by both the engine E and the drive motor M.

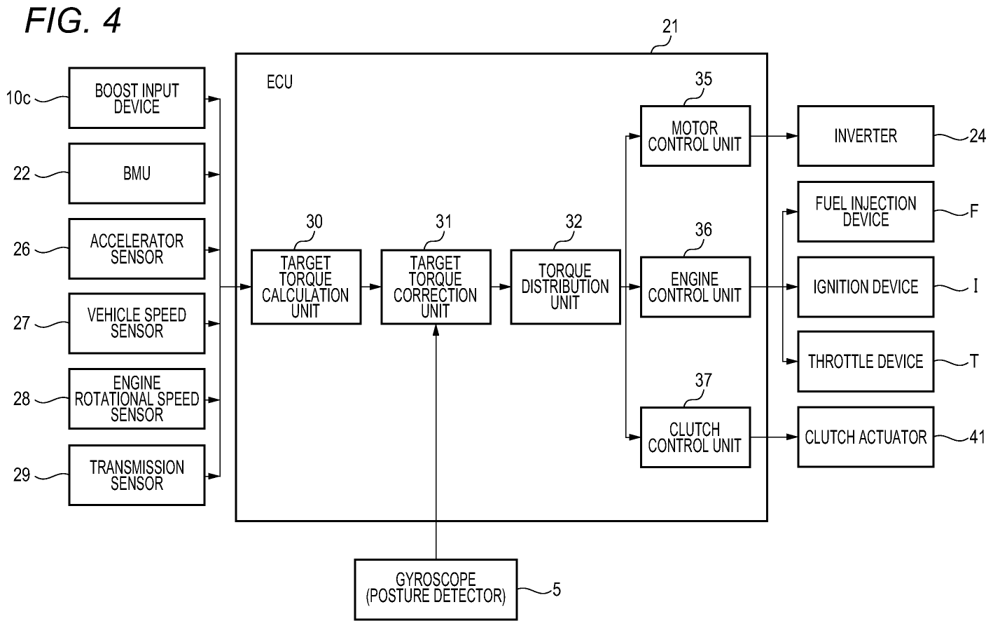

FIG. 4 is a block diagram of a control system of the straddle type vehicle 1 illustrated in FIG. 1. The ECU 21 receives output signals of the boost input device 10c, the BMU 22, an accelerator sensor 26, a vehicle speed sensor 27, an engine rotational speed sensor 28, a transmission sensor 29, and the like. When the gyroscope 5 detects that the straddle type vehicle 1 is inclined in the left-right direction, the gyroscope 5 outputs an inclination signal to the ECU 21, and the ECU 21 receives the inclination signal output from the gyroscope 5. The boost input device 10c receives a boost command from the rider when pressed by the rider. When the boost input device 10c is pressed, a boost signal is input to the ECU 21, and the ECU 21 detects a boost command of the rider. The BMU 22 detects a remaining amount, a voltage, and the like of the battery 23. The accelerator sensor 26 detects an operation amount of the accelerator operator 10a operated by the rider (that is, an acceleration/deceleration request degree). The vehicle speed sensor 27 detects a traveling speed of the straddle type vehicle 1. The engine rotational speed sensor 28 detects the rotational speed of the crankshaft Ea of the engine E. The transmission sensor 29 detects a gear position of the engaged gear train in the transmission 14.

In terms of hardware, the ECU 21 includes a processor, a system memory, a storage memory, and an input/output interface. The processor may include, for example, a central processing unit (CPU). The system memory may include a random access memory (RAM). The storage memory may include a read only memory (ROM). The storage memory may include a hard disk and/or a flash memory. The storage memory stores a program. The configuration for the processor to execute the program read into the system memory is an example of the processing circuit. In terms of function, the ECU 21 includes a target torque calculation unit 30, a target torque correction unit 31, a torque distribution unit 32, a motor control unit 35, an engine control unit 36, and a clutch control unit 37. The units 30 to 37 of the ECU 21 are realized by the processor executing the program read into the system memory. The target torque calculation unit 30 calculates the target torque of the drive wheel when the straddle type vehicle 1 travels, based on the received output signals from the boost input device 10c, the BMU 22, the accelerator sensor 26, the vehicle speed sensor 27, the engine rotational speed sensor 28, the transmission sensor 29, and the like. When the straddle type vehicle 1 is inclined in the left-right direction, the target torque correction unit 31 corrects the target torque calculated by the target torque calculation unit 30, based on the inclination signal transmitted from the gyroscope 5. The torque distribution unit 32 distributes the target torque corrected by the target torque correction unit 31 to the drive motor M and the engine E. That is, the torque distribution unit 32 determines the ratio for distributing the torque (torque distribution) to the drive motor M and the engine E, and distributes the torque required for each of the drive motor M and the engine E based on the determined ratio.

The motor control unit 35 is connected to the inverter 24. The engine control unit 36 is connected to the fuel injection device F, the ignition device I, and the throttle device 40. The clutch control unit 37 is connected to a clutch actuator 41. The inverter 24 adjusts electric power supplied to the drive motor M and controls driving by the drive motor M. The fuel injection device F adjusts the amount of fuel supplied to the combustion chamber of the engine E. The ignition device I controls ignition in the engine E. The throttle device 40 adjusts the amount of intake air in the engine E. Driving by the engine E is controlled by controlling the fuel injection device F, the ignition device I, and the throttle device 40. The clutch actuator 41 controls whether to drive the rear wheel 3 by the engine E, by the drive motor M, or by both the engine E and the drive motor M by controlling connection or disconnection of the main clutch 16 and the sprockets 17 and 18.

The motor control unit 35, the engine control unit 36, and the clutch control unit 37 control driving of the power unit 13 when the straddle type vehicle 1 travels. By the processor in the ECU 21 performing calculation, the target torque calculation unit 30 calculates the target torque. At this time, in the present embodiment, the target torque calculation unit 30 calculates the target torque based on the output signals from the boost input device 10c, the BMU 22, the accelerator sensor 26, the vehicle speed sensor 27, the engine rotational speed sensor 28, the transmission sensor 29, and the like in accordance with the program stored in the memory of the ECU 21.

The motor control unit 35 controls the operation of the drive motor M by controlling the inverter 24 in response to a command from the torque distribution unit 32. The engine control unit 36 controls the operation of the engine E by controlling the fuel injection device F, the ignition device I, and the throttle device 40 in accordance with a command from the torque distribution unit 32. The clutch control unit 37 controls the clutch actuator 41 in accordance with a command from the torque distribution unit 32.

Next, the torque control of the straddle type vehicle 1 according to the present embodiment will be described. In the straddle type vehicle 1, when the boost input device 10c is not pressed by the rider and no boost command is input to the boost input device 10c by the rider, the straddle type vehicle 1 travels with the target torque set to the normal torque. Therefore, in this case, the ECU 21 determines the target torque of the power unit (traveling drive source) 13 as the normal torque in accordance with a predetermined travel rule such as a torque map. When the target torque is set to the normal torque, the target torque calculation unit 30 calculates the target torque based on the output signals from the BMU 22, the accelerator sensor 26, the vehicle speed sensor 27, the engine rotational speed sensor 28, and the like according to a predetermined travel rule. In the present embodiment, when the target torque is set to the normal torque, only the engine E of the power unit 13 drives the rear wheel 3.

When the rider presses the boost input device 10c, a boost command from the rider is input to the ECU 21 via the boost input device 10c. When the ECU 21 receives the boost signal from the boost input device 10c, the ECU 21 changes the target torque to a boost torque obtained by adding a predetermined boost amount to the normal torque. At this time, the target torque calculation unit 30 calculates the boost torque obtained by adding the boost amount to the normal torque, and changes the target torque to the boost torque. In the present embodiment, when the target torque is changed to the boost torque, the power unit 13 causes the engine E to generate a torque corresponding to the normal torque to drive the rear wheel 3, and causes the drive motor M to generate a torque corresponding to the boost amount to drive the rear wheel 3. That is, the torque distribution unit 32 of the ECU 21 determines the torque distribution between the engine E and the drive motor M such that the engine E generates the drive force corresponding to the normal torque and the drive motor M generates the drive force corresponding to the boost amount. When the target torque is changed to the boost torque, the torque generated by the power unit 13 may be increased to the boost torque by increasing only the torque generated by the drive motor M in a state where the torque generated by the engine E is constant. Alternatively, when the target torque is changed to the boost torque, the torque generated by the power unit 13 may be increased to the boost torque by increasing the torque generated by the drive motor M while increasing the torque generated by the engine E. That is, the torque generated by the power unit 13 may be increased to the boost torque by increasing both the torque generated by the drive motor M and the torque generated by the engine E. When the target torque is to be changed to the boost torque, the engine E may generate a part of the torque corresponding to the boost amount.

In the present embodiment, since the drive motor M generates the torque corresponding to the boost amount to drive the rear wheel 3, when the boost command is input to the straddle type vehicle 1 by the rider via the boost input device 10c, due to the high responsiveness, the rear wheel 3 is driven by the torque added with the boost amount. In general, a motor has a higher responsiveness of output to input than an engine. Therefore, since the drive motor M is configured to generate the torque corresponding to the boost amount when the boost command is input, it is possible to provide a straddle type vehicle 1 that generates the boost torque with high responsiveness.

When the ECU 21 receives the boost signal and the target torque calculation unit 30 changes the target torque to the boost torque, if the ECU 21 receives an inclination signal transmitted from the gyroscope 5, the ECU 21 corrects the target torque. Specifically, when the ECU 21 receives the inclination signal, the ECU 21 corrects the target torque such that a torque change of the rear wheel 3 when the target torque is changed from the normal torque to the boost torque is decreased as compared with a case where the ECU 21 does not receive the inclination signal. In the present embodiment, when the ECU 21 receives the inclination signal, the ECU 21 corrects the target torque such that the boost amount is decreased as compared with a case where the ECU 21 does not receive the inclination signal.

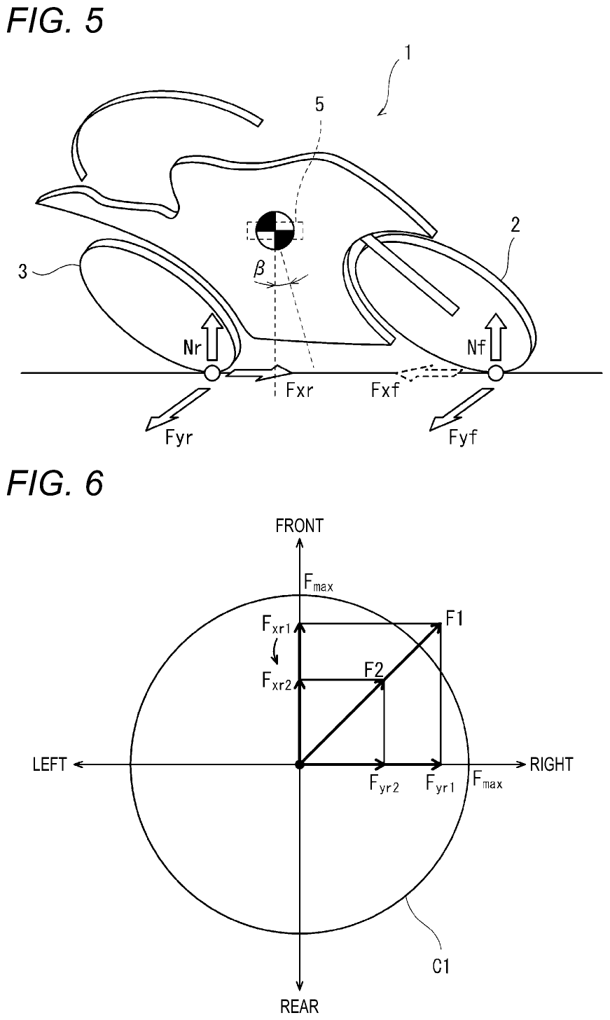

FIG. 5 is a schematic perspective view of the straddle type vehicle 1 when the straddle type vehicle 1 is inclined in the left-right direction. Hereinafter, the inclination angle when the straddle type vehicle 1 is inclined in the left-right direction is also referred to as a “bank angle”. The straddle type vehicle 1 in FIG. 5 is inclined in the left-right direction at a bank angle β. FIG. 5 illustrates tire forces that are forces acting on the respective tires of the front wheel 2 and the rear wheel 3 from the road surface. As illustrated in FIG. 5, among the tire forces acting on the rear wheel 3, the tire force acting in the front-rear direction is denoted by Fxr, the tire force acting in the left-right direction is denoted by Fyr, and the tire force acting in the upper-lower direction is denoted by Nr. Among the tire forces acting on the front wheel 2, the tire force acting in the front-rear direction is denoted by Fxf, the tire force acting in the left-right direction is denoted by Fyf, and the tire force acting in the upper-lower direction is denoted by Nf. Since the rear wheel 3 is the drive wheel, when the drive force is transmitted to the rear wheel 3 by the power unit 13, Fxr acting forward acts on the rear wheel 3. Since the front wheel 2 is the driven wheel, the drive force is not transmitted to the front wheel 2, but when a braking force acts on the front wheel 2, a tire force acts in the direction indicated by Fxf in FIG. 5. When a braking force acts on the rear wheel 3, a tire force in the same direction as Fxf acts on the rear wheel 3.

When the straddle type vehicle 1 is upright and the bank angle β is zero, only the tire force Fxr in the front-rear direction acts as the tire force of the rear wheel 3 as the drive wheel. On the other hand, as illustrated in FIG. 5, when the straddle type vehicle 1 is inclined in the left-right direction and the bank angle β is generated in the straddle type vehicle 1, in accordance with the inclination of the straddle type vehicle 1 in the left-right direction, not only the tire force Fxr in the front-rear direction but also the tire force Fyr in the lateral direction are generated as the tire force of the rear wheel 3 as the drive wheel. Therefore, the resultant force of the tire force Fxr in the front-rear direction and the tire force Fyr in the lateral direction when the straddle type vehicle 1 is inclined and the bank angle β is generated is larger than the tire force Fxr only in the front-rear direction when the straddle type vehicle 1 is upright.

FIG. 6 is an explanatory view illustrating the tire force acting on the tire of the rear wheel 3 and a friction circle C1 of the tire of the rear wheel 3 when the straddle type vehicle 1 is inclined in the left-right direction. In FIG. 6, when the target torque is changed from the normal torque to the boost torque, the straddle type vehicle 1 is inclined in the left-right direction. Therefore, the tire force Fxr1 in the front-rear direction and the tire force Fyr1 in the lateral direction are illustrated and the tire force F1 as the resultant force thereof is illustrated. In addition, the tire force Fxr2 in the front-rear direction and the tire force Fyr2 in the lateral direction when the ECU 21 receives the inclination signal transmitted from the gyroscope 5 and the target torque is corrected such that the boost amount is decreased are illustrated, and the tire force F2 as the resultant force thereof is illustrated.

In the example of FIG. 6, the tire force F1, which is the resultant force of the tire force Fxr1 in the front-rear direction and the tire force Fyr1 in the lateral direction when the straddle type vehicle 1 is inclined in the left-right direction when the target torque is set to the boost torque, exceeds the friction circle C1 of the rear wheel 3. When the resultant force of the tire force Fxr in the front-rear direction and the tire force Fyr in the lateral direction when the straddle type vehicle 1 is inclined exceeds the friction circle C1 of the tire, a side slip may occur in the rear wheel 3.

In the present embodiment, as described above, when the ECU 21 receives the inclination signal transmitted from the gyroscope 5, the target torque is corrected such that the boost amount is decreased. In FIG. 6, as a result of correcting the target torque such that the boost amount is decreased, the resultant force F2 of the tire force Fxr2 in the front-rear direction and the tire force Fyr2 in the lateral direction is corrected to be smaller than the resultant force F1 when the correction is not performed. Therefore, the resultant force F2 of the tire force Fxr2 in the front-rear direction and the tire force Fyr2 in the lateral direction falls within the friction circle C1 of the tire of the rear wheel 3.

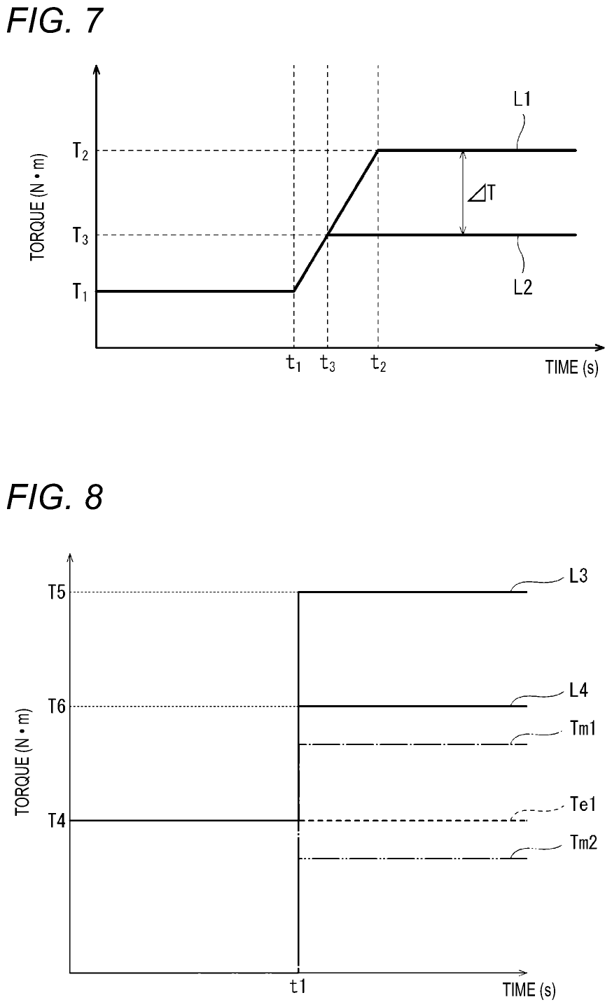

FIG. 7 is a graph illustrating the correlation between the driving torque of the rear wheel 3 and the time. In FIG. 7, the vertical axis represents the driving torque [N·m] of the rear wheel 3, and the horizontal axis represents the time [s]. The time t1 is a time when the boost input device 10c is pressed by the rider and the boost signal is received by the ECU 21. The time t2 is a time at which the driving of the rear wheel 3 by the changed target torque is started when the target torque is changed from the normal torque to the boost torque in a state where the inclination of the vehicle body is not detected. The time t3 is a time at which the driving of the rear wheel 3 by the changed target torque is started when the target torque is changed from the normal torque to the boost torque in a state where the inclination of the vehicle body is detected. The transition of the torque when the rear wheel 3 is driven by the boost torque when the straddle type vehicle 1 is not inclined in the left-right direction and the correction of the target torque is not performed is indicated by a line L1. The transition of the torque when the rear wheel 3 is driven by the boost torque when the straddle type vehicle 1 is inclined in the left-right direction and the correction of the target torque is performed is indicated by a line L2.

As illustrated in FIG. 7, the rear wheel 3 is driven with a normal torque T1 before the boost input device 10c is pressed by the rider. When the boost input device 10c is pressed by the rider at the time t1, the target torque is changed from the normal torque to the boost torque, and the torque for driving the rear wheel 3 increases. At this time, if the gyroscope 5 does not detect the inclination of the straddle type vehicle 1 in the left-right direction, the ECU 21 determines that the straddle type vehicle 1 is upright, and thus the rear wheel 3 is driven by a torque T2 obtained by adding the boost torque to the normal torque T1. When the gyroscope 5 detects that the straddle type vehicle 1 is inclined in the left-right direction, the ECU 21 determines that the straddle type vehicle 1 is inclined, and the rear wheel 3 is driven with a torque T3 obtained by decreasing the boost amount by ΔT from the torque T2 when the inclination is not detected. At the time t3 when the driving torque of the rear wheel 3 reaches the torque T3, the driving torque stops increasing, and the rear wheel 3 is driven with the torque T3 afterwards. Between the time t1 and the time t3, a torque change amount per unit time obtained by dividing the torque increase amount when the torque increases by the time is the same between torque transition L1 when the straddle type vehicle 1 is not inclined in the left-right direction and torque transition L2 when the straddle type vehicle 1 is inclined in the left-right direction. In the torque transition L1 when the inclination of the straddle type vehicle 1 is not detected, the torque continues increasing even after the time t3 at which the torque reaches T3, and increases until the time t2 at which the torque reaches T2. In the torque transition L2 when the inclination of the straddle type vehicle 1 is detected, the torque stops increasing at the time t3 when the torque reaches T3. The torque change amount per unit time may be different between the torque transition L1 when the straddle type vehicle 1 is not inclined in the left-right direction and the torque transition L2 when the straddle type vehicle 1 is inclined in the left-right direction.

When the boost input device 10c is pressed by the rider, the target torque is set such that the torque T3 of the rear wheel 3 when the inclination of the straddle type vehicle 1 in the left-right direction is detected by the gyroscope 5 is smaller than the torque T2 of the rear wheel 3 when the inclination of the straddle type vehicle 1 in the left-right direction is not detected. In the present embodiment, when the inclination of the straddle type vehicle 1 in the left-right direction is detected, the target torque is set such that the tire force acting on the tire falls within the friction circle C1 of the tire of the rear wheel 3 as a result of the boost amount being added to the normal torque and the torque with the boost amount corrected acting on the rear wheel 3. Therefore, the rider can ride the straddle type vehicle 1 comfortably.

FIG. 8 is a graph illustrating the correlation between the target torque and the time. In FIG. 8, the vertical axis represents the target torque, and the horizontal axis represents the time [s]. Similarly to FIG. 7, the time t1 is a time when the boost input device 10c is pressed by the rider and the boost signal is received by the ECU 21. A target torque before the boost input device 10c is pressed by the rider is defined as T4, a target torque in a case where the straddle type vehicle 1 is not inclined when the boost input device 10c is pressed by the rider is defined as T5, and a target torque in a case where the straddle type vehicle 1 is inclined when the boost input device 10c is pressed by the rider is defined as T6. The transition of the target torque when the straddle type vehicle 1 is not inclined is defined as L3, and the transition of the target torque when the straddle type vehicle 1 is inclined is defined as L4.

When the boost input device 10c is pressed by the rider and the boost signal is received by the ECU 21, the target torque is changed to the boost torque. At this time, if the straddle type vehicle 1 is not inclined, the target torque is set to T5. Therefore, as indicated by L3 in FIG. 8, the transition of the target torque rises to the torque T5 at the time t1, and then the target torque is maintained at the torque T5. At this time, the target torque T5 is distributed by the torque distribution unit 32 to a target torque distributed to the engine E and a target torque distributed to the drive motor M. In the present embodiment, the torque distributed to the engine E does not change before and after the timing at which the boost input device 10c is pressed by the rider. The torque distributed to the drive motor M is 0 before the boost input device 10c is pressed by the rider. When the boost input device 10c is pressed by the rider, the driving torque corresponding to the boost amount is distributed to the drive motor M.

As illustrated in FIG. 8, at a time before the time t1 at which the boost input device 10c is pressed, the target torque of the engine E is T4, and the target torque of the drive motor M is 0. In FIG. 8, the target torque of the engine E on and after the time t1 is defined as Te1. The target torque of the drive motor M when the straddle type vehicle 1 is not inclined on and after the time t1 is defined as Tm1. The target torque of the drive motor M when the straddle type vehicle 1 is inclined on and after the time t1 is defined as Tm2. The target torque Tm2 of the drive motor M when the straddle type vehicle 1 is inclined on and after the time t1 the time t1 is smaller than the target torque Tm1 of the drive motor M when the straddle type vehicle 1 is not inclined.

The total target torque when the straddle type vehicle 1 is not inclined on and after the time t1 is T5 which is the total of the target torque Te1 of the engine E and the target torque Tm1 of the drive motor M. The total target torque when the straddle type vehicle 1 is inclined on and after the time t1 is T6 which is the total of the target torque Te1 of the engine E and the target torque Tm2 of the drive motor M. As a result, if the straddle type vehicle 1 is not inclined when the boost input device 10c is pressed by the rider and the boost signal is received by the ECU 21, the target torque is set to T5, and the target torque transitions as indicated by L3 in FIG. 8. If the straddle type vehicle 1 is inclined when the rider pushes the boost input device 10c and the boost signal is received by the ECU 21, the target torque is set to T6, which is smaller than T5. Therefore, the target torque rises to the torque T6 at the time t1, and thereafter, the target torque is maintained at the torque T6 and transitions as indicated by L4 in FIG. 8.

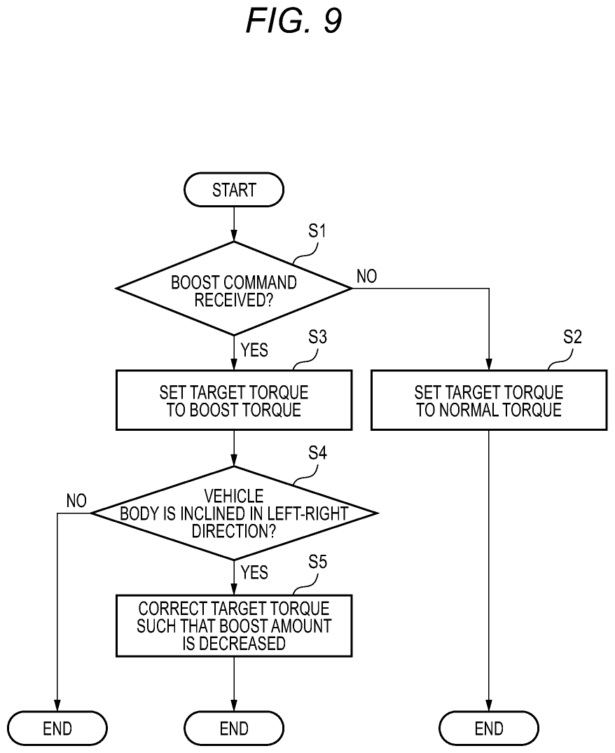

Next, a method for controlling the straddle type vehicle 1 according to the present embodiment will be described with reference to the flowchart of FIG. 9. First, the ECU 21 determines whether the ECU 21 has received the boost command (S1). If the ECU 21 does not receive the boost command, the target torque is set to the normal torque (S2). If the ECU 21 receives the boost command, the target torque is set to the boost torque obtained by adding the boost amount to the normal torque (S3). Next, the gyroscope 5 detects whether the vehicle body of the straddle type vehicle 1 is inclined in the left-right direction (S4). When it is detected that the vehicle body of the straddle type vehicle 1 is inclined in the left-right direction, the target torque is corrected such that the boost amount is decreased (S5). When it is not detected that the vehicle body of the straddle type vehicle 1 is inclined in the left-right direction, the target torque becomes the boost torque set in S3.

In the present embodiment, when the inclination of the straddle type vehicle 1 is detected by the gyroscope 5, the decrease amount of the target torque (ΔT in FIG. 7) when the boost amount of the target torque is corrected to be decreased is constant regardless of the inclination of the straddle type vehicle 1. The boost amount decrease amount ΔT is set such that the tire force acting on the tire of the rear wheel 3 reliably falls within the friction circle C1 even when the straddle type vehicle 1 is largely inclined. Therefore, even when the straddle type vehicle 1 is largely inclined, the tire force acting on the tire of the rear wheel 3 falls within the friction circle C1, and the rider can ride the vehicle comfortably.

The above embodiment has described an aspect in which the decrease amount ΔT of the boost amount when the inclination of the straddle type vehicle 1 is detected is constant regardless of the inclination of the straddle type vehicle 1, but the invention is not limited to the above embodiment. The torque control of the rear wheel 3 may be performed such that the decrease amount ΔT of the boost amount changes in accordance with the degree of inclination of the straddle type vehicle 1. For example, the gyroscope 5 may be configured to be capable of detecting the inclination angle in the left-right direction with respect to the vertical direction of the straddle type vehicle 1, and may be configured to change the decrease amount ΔT of the target torque when the boost amount of the target torque is corrected in accordance with the inclination angle detected by the gyroscope 5. That is, in correcting the target torque such that the boost amount is decreased, which is performed in S5 of the flowchart of FIG. 9, the target torque may be corrected to increase the decrease amount of the torque change of the rear wheel 3 as the detected inclination angle of the straddle type vehicle 1 increases. That is, the correction of the target torque may include increasing the decreasing correction amount ΔT of the boost amount as the inclination angle of the straddle type vehicle 1 increases.

The magnitude of ΔT in FIG. 7 changes when the decrease amount in the boost amount changes in accordance with the degree of inclination of the straddle type vehicle 1. In the present embodiment, the target torque T6 when the boost amount is decreased can change over a range from the target torque T5 when the target torque corresponding to the boost torque is added to the target torque corresponding to the normal torque to the target torque T4 corresponding to the normal torque. As a result, the torque after the boost input device 10c is pressed by the rider can change over a range from the torque T2 to the torque T1 in accordance with the degree of inclination of the straddle type vehicle 1. When the degree of inclination of the straddle type vehicle 1 is large, the decrease amount ΔT of the boost amount is large, and the corrected target torque T3 becomes a value close to the normal torque T1. On the other hand, when the degree of inclination of the straddle type vehicle 1 is small, the decrease amount ΔT of the boost amount is small, and the corrected target torque T3 becomes a value close to the target torque T2 obtained by adding the boost torque to the normal torque. Since the corrected target torque T3 is changed in accordance with the inclination angle of the straddle type vehicle 1, when the inclination angle is large, the target torque T3 is decreased to set the target torque such that the tire force acting on the tire of the rear wheel 3 falls within the friction circle C1, and when the inclination angle is small, the target torque T3 is increased to set a large target torque by boosting, thereby driving the rear wheel 3 with a large torque. Therefore, the rider can ride the straddle type vehicle 1 with the target torque corresponding to the inclination angle, and the rider can ride the vehicle more comfortably.

In the present embodiment, the engine E generates a torque corresponding to the normal torque T1 to drive the rear wheel 3, and the drive motor M generates a torque corresponding to the boost amount to drive the rear wheel 3. Therefore, during normal traveling in a state where the boost command is not input, the engine E generates the normal torque T1 used during the normal traveling. When the boost command is input by the rider, the drive motor M generates a torque corresponding to the boost amount. Therefore, in the present embodiment, when the boost command is input when the vehicle body is inclined and the boost amount added to the normal torque is corrected in accordance with the degree of inclination, the boost amount is adjusted by adjusting the drive of the drive motor M. That is, in the present embodiment, by changing the driving of the drive motor M, T3 obtained by adding the corrected boost amount to the normal torque T1 can change between the normal torque T1 and the boost torque T2.

Further, in the present embodiment, when the boost input device 10c is pressed continuously, the boost signal is continuously transmitted to the ECU 21. Therefore, when the boost input device 10c is pressed continuously and the boost command by the rider is continuously input to the straddle type vehicle 1, the boost input device 10c continuously transmit the boost signal to the ECU 21 in response. The straddle type vehicle 1 is configured such that the correction of the target torque can be continuously performed at this time. In the present embodiment, the ECU 21 is configured to continuously correct the target torque in accordance with a latest inclination signal received from the gyroscope 5 during a period in which the boost signal is continuously received from the boost input device 10c.

When the boost input device 10c is pressed continuously, the correction of the target torque is also performed continuously. During this time, since the straddle type vehicle 1 travels continuously, the road condition around the straddle type vehicle 1 may change. In the present embodiment, since the ECU 21 corrects the target torque in accordance with the latest inclination signal received from the gyroscope 5, the straddle type vehicle 1 can correct the target torque in accordance with the changing road condition. For example, when a relatively gentle curve and a relatively sharp curve are mixed in one curve, the straddle type vehicle 1 travels at a relatively small bank angle β while traveling on the gentle curve, and the straddle type vehicle 1 travels at a relatively large bank angle β while traveling on the steep curve. At this time, when the rider continuously presses the boost input device 10c while the rider is traveling on the curve, the target torque T3 is increased in accordance with the small bank angle of the straddle type vehicle 1 while the rider is traveling on the gentle curve, whereas the target torque T3 is decreased in accordance with the large bank angle of the straddle type vehicle 1 while the rider is traveling on the steep curve. Accordingly, the rider can cause the straddle type vehicle 1 to travel with an appropriate target torque based on the latest inclination signal in each curve, in accordance with the difference in the inclination angle of the straddle type vehicle 1 caused by the difference in the degree of the curve for each position. Therefore, the rider can ride the straddle type vehicle 1 more comfortably.

In addition, the decrease amount ΔT of the boost amount may change in accordance with the gear position of the transmission 14 detected by the transmission sensor 29. As described above, the transmission sensor 29 is configured to capable of detecting the gear position of the engaged gear train in the transmission 14. Therefore, the gear ratio of the transmission 14 at the time of detection can be detected based on the meshing gear train. Therefore, the target torque may be set in accordance with the gear ratio detected by the transmission sensor 29 such that the torque change of the rear wheel 3 decreases as the gear ratio detected by the transmission sensor 29 increases. In the present embodiment, as the gear ratio detected by the transmission sensor 29 is larger, the decreasing correction amount ΔT of the boost amount is set larger so that the torque change becomes smaller.

When the gear ratio of the transmission 14 is large, the decreasing correction amount ΔT of the boost amount in FIG. 7 is set large, and the target torque T3 is set small. Thus, when the gear ratio of the transmission 14 is large, the corrected target torque T3 becomes a value close to the normal torque T1. Therefore, the torque change is decreased by decreasing the change of the target torque from the normal torque T1, and the operability of the straddle type vehicle 1 can be improved. On the other hand, when the gear ratio of the transmission 14 is small, the decreasing correction amount ΔT of the boost amount is set small, so that the target torque T3 becomes a value close to the torque T2 obtained by adding the boost amount to the normal torque, and the target torque T3 is set large. As a result, when the gear ratio is small, the target torque becomes a value close to the boost torque, and a larger boost effect can be obtained.

In general, when the gear ratio of the straddle type vehicle 1 is large, when the rider performs an operation involving torque change of the drive wheel, the rear wheel 3 responds more to the operation performed by the rider. Therefore, when the gear ratio is large, when the rider gives a boost command to the ECU 21 by pressing the boost input device 10c, a torque change of an amount exceeding the output intended by the rider may act on the rear wheel 3 in response to the rider's operation, and thus the rider cannot ride the vehicle comfortably. Therefore, by decreasing the change from the normal torque T1 when the gear ratio of the transmission 14 is large as in the present embodiment, the operability of the straddle type vehicle 1 can be improved. Accordingly, the rider can have improved operability when the gear ratio is large in the straddle type vehicle 1, and can obtain a larger boost effect when the gear ratio is small. Therefore, the rider can ride the vehicle more comfortably.

When the gyroscope 5 detects that the vehicle body is inclined, the torque control of the driving torque to the rear wheel 3 may be performed such that the straddle type vehicle 1 travels with the normal torque T1 without adding the boost amount to the normal torque T1. That is, when the boost signal is input to the ECU 21, the drive force by the drive motor M may be applied when the inclination of the vehicle body is not detected, and the drive force by the drive motor M may not be applied when the inclination of the vehicle body is detected. Accordingly, the torque control for the rear wheel 3 can be performed simply by the on/off operation of the drive motor M, and the torque control can be performed easily.

According to the above embodiment, when the inclination of the vehicle body is detected when the target torque is changed from the normal torque T1 to the boost torque T2, the target torque is corrected such that the torque change of the rear wheel 3 decreases. Therefore, it is possible to provide a straddle type vehicle 1 sets with the boost torque T2 or T3 is set in accordance with the respective postures of the upright state of the vehicle and the inclined state of the vehicle, and capable of setting a suitable boost torque for each traveling state.

In addition, since the correction of the target torque includes correction of decreasing the boost amount, the boost amount is corrected to decrease when the vehicle body is inclined. Therefore, it is possible to easily decrease the torque change of the rear wheel 3 when the target torque is changed from the normal torque T1 to the boost torque T3.

In addition, since the correction of the target torque includes increasing the decreasing correction amount of the boost amount as the inclination angle of the vehicle body detected by the gyroscope 5 increases, the boost torque becomes an appropriate value corresponding to the inclination angle of the vehicle body. Therefore, when the vehicle body is largely inclined, the traveling drive source is controlled such that the drive force of the rear wheel 3 falls within a range within the friction limit of the tire which is decreased in accordance with the inclination of the vehicle body. Accordingly, it is possible to limit the drive force of the rear wheel 3 from exceeding the friction limit of the tire. When the vehicle body is inclined slightly, the drive force of the rear wheel 3 increases in accordance with the inclination of the vehicle body. Therefore, the rider can obtain a sufficient boost effect, and the rider can ride the vehicle comfortably.

Further, the correction of the target torque includes correcting the target torque such that the decrease amount of the torque change of the rear wheel 3 is increased as the gear ratio detected by the transmission sensor 29 increases. Therefore, the decrease amount in the torque change increases as the gear ratio increases, so that the decreasing correction amount of the boost amount increases, and the torque change of the rear wheel 3 is limited sufficiently. On the other hand, the decrease amount in the torque when correcting the target torque of the rear wheel 3 decreases as the gear ratio decreases, and a sufficient boost effect can be obtained. Therefore, it is possible to achieve both the boost effect and excellent operability.

In addition, by correcting the target torque, the ECU 21 continuously corrects the target torque while the ECU 21 continuously receives the boost signal, so that the boost effect can be continuously obtained while the rider gives the boost command. Therefore, the rider can continuously obtain the boost effect, and it is possible to provide a straddle type vehicle 1 having excellent usability. Further, the ECU 21 corrects the target torque in accordance with the latest inclination signal received from the gyroscope 5, and thus can correct the target torque in accordance with the latest surrounding situation. Therefore, it is possible to correct the target torque suitable for the surrounding situation at that time in response to a change in the surrounding situation of the straddle type vehicle 1, and it is possible to provide a straddle type vehicle 1 having better usability.

Further, since the torque distribution is determined by the torque distribution unit 32 such that the drive motor M generates the drive force corresponding to the boost amount, the target torque is changed simply by correction of decreasing the torque by the drive motor M. Therefore, the target torque can be changed by simple control.

### Second Embodiment

Next, a straddle type vehicle according to a second embodiment will be described. Description of portions having the same configurations as those in the first embodiment will be omitted, and only different portions will be described. In the first embodiment, when the inclination of the vehicle body is detected when the ECU 21 receives the boost command, the correction amount ΔT for the target torque is increased, thereby correcting the target torque such that the magnitude of the target torque T3 is decreased and the torque change of the drive wheel is decreased. The second embodiment is different from the first embodiment in that, when the inclination of the vehicle body is detected when the ECU 21 receives the boost command, the transition of the target torque is corrected such that the increase rate per unit time until the target torque transitions from the normal torque to the torque added with the boost amount is decreased.

FIG. 10 is a graph illustrating the correlation between the driving torque of the rear wheel 3 and the time in the straddle type vehicle according to the second embodiment. In the second embodiment, the corrected target torque is the torque T2 obtained by adding the boost amount to the normal torque T1, regardless of whether the inclination of the vehicle body is detected or not detected. In the second embodiment, the time from when the boost command is input from the rider via the boost input device 10c to when the target torque becomes the torque T2 obtained by adding the boost amount to the normal torque T1 is different between when the inclination of the vehicle body is detected and when the inclination of the vehicle body is not detected.

In FIG. 10, the transition of the torque when the inclination of the vehicle body is not detected is indicated by a line L5, and the transition of the torque when the inclination of the vehicle body is detected is indicated by a line L6. The time when the boost command is input to the straddle type vehicle 1 via the boost input device 10c is defined as the time t1, the time when the target torque T2 is reached when the inclination of the vehicle body is not detected is defined as the time t2, and the time when the target torque T2 is reached when the inclination of the vehicle body is detected is defined as a time t4. A difference between the time t2 at which the driving torque of the rear wheel 3 reaches the target torque T2 when the inclination of the vehicle body is not detected and the time t4 at which the driving torque of the rear wheel 3 reaches the target torque T2 when the inclination of the vehicle body is detected is Δt.

In the present embodiment, a normal transition state (t1 to t2 of L5) refers to a state in which the gyroscope 5 does not detect the inclination of the vehicle body so that the ECU 21 does not receive the inclination signal from the gyroscope 5, and the ECU 21 causes the target torque to transition from the normal torque to the boost torque, while the actual driving torque when driving the rear wheel 3 transitions from T1 to T2. An inclination transition state (t1 to t4 of L6) refers to a state in which the ECU 21 receives the inclination signal from the gyroscope 5, and the ECU 21 causes the target torque to transition from the normal torque to the boost torque, while the actual driving torque when driving the rear wheel 3 transitions from T1 to T2. At this time, in the torque change (transient torque) when the torque is changed from the normal torque to the boost torque, the time taken for the torque change when the inclination of the vehicle body is detected by the gyroscope 5 (t1 to t4) is longer than the time taken for the torque change when the inclination of the vehicle body is not detected by the gyroscope 5 (t1 to t2). Therefore, the increase rate per unit time (L6) of the torque at the time of the torque change when the inclination of the vehicle body is detected is smaller than the increase rate per unit time (L5) of the torque at the time of the torque change when the inclination of the vehicle body is not detected. That is, the ECU 21 corrects the target torque in the inclination transition state such that the increase rate per unit time (L5) of the transient torque of the rear wheel 3 in the inclination transition state is decreased relative to the increase rate per unit time (L6) of the transient torque of the rear wheel 3 in the normal transition state.

When the vehicle body is inclined, the straddle type vehicle 1 is more likely to be affected by the torque change than when the vehicle body is not inclined. Therefore, when the torque change of the rear wheel 3 increases when the vehicle body is inclined, the operability of the vehicle body during the ride may be affected thereby. In the present embodiment, when the vehicle body is inclined, the increase rate per unit time of the transient torque of the drive wheel 3 is decreased, so that the torque change per unit time of the drive wheel 3 when the vehicle body is inclined is limited small, and the rider can ride the vehicle comfortably without being much affected by the torque change.

In addition, since the time required for the actual driving torque to transition from the normal torque T1 to the boost torque T2 is long, the rider can take measures even when the driving torque of the rear wheel 3 increases from the normal torque T1 to the boost torque T2 when the vehicle body is inclined. For example, even when the posture of the straddle type vehicle 1 is changed such that the vehicle body transitions from the inclined state to the upright state and the driving torque to the rear wheel 3 is increased, the straddle type vehicle 1 can be ridden such that the tire force acting on the tire falls within the friction circle C1 of the tire. When the posture of the straddle type vehicle 1 is changed such that the vehicle body transitions from the inclined state to the upright state of the vehicle body, the tire force in the lateral direction among the tire forces acting on the tire of the rear wheel 3 becomes small, so that the resultant force of the tire force in the front-rear direction and the tire force in the lateral direction can be made to fall within the friction circle C1 of the tire. In addition, for example, since there is a time margin until the transition from the normal torque T1 to the boost torque T2, the input of the boost command can be stopped by the rider releasing the finger from the boost input device 10c. Further, in a case where the application of the driving torque to the rear wheel 3 is continued for a certain period of time when the rider presses the boost input device 10c, and an operator for stopping the boost for increasing the driving torque to the rear wheel 3 from the normal torque T1 to the boost torque T2 is provided separately from the boost input device 10c, the boost can be stopped by the rider operating the operator for stopping the boost.

In the present embodiment, the time (t1 to t4) taken for the torque change when the inclination of the vehicle body is detected is constant regardless of the degree of inclination. The time required for the torque change when the inclination of the vehicle body is detected is set to secure a time margin sufficient for the rider to take measures even when the boost command is input to the ECU 21 and the driving torque to the rear wheel 3 is increased from the normal torque T1 to the boost torque T2 when the vehicle body is largely inclined. Therefore, the rider can take measures with a margin even when the boost command is input to the ECU 21 when the straddle type vehicle 1 is largely inclined, and the rider can ride the vehicle comfortably.

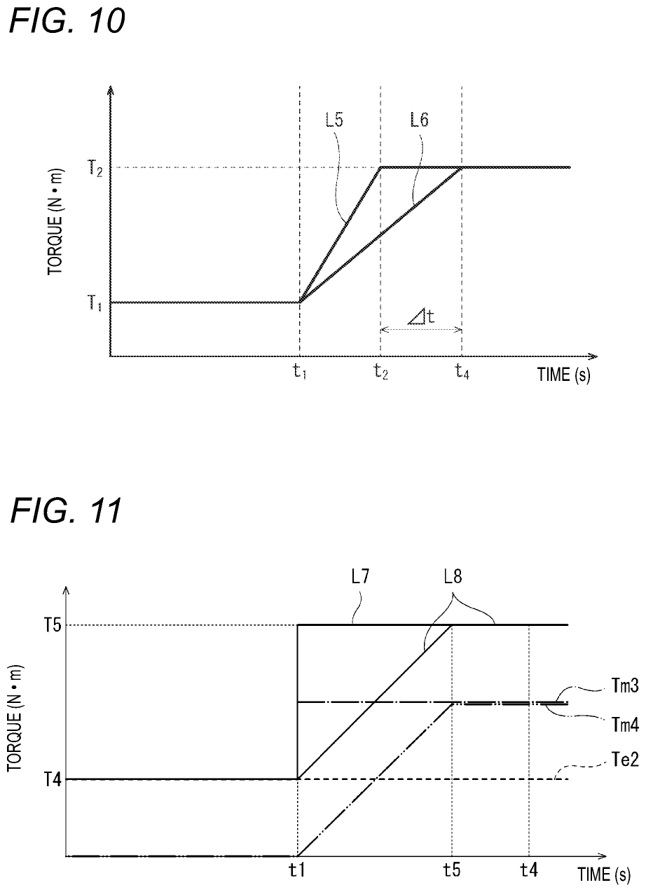

FIG. 11 is a graph illustrating the correlation between the target torque for the driving torque of the rear wheel 3 and the time. In FIG. 11, the vertical axis represents the target torque, and the horizontal axis represents the time [s]. In the present embodiment, when the vehicle body is inclined, the increase rate per unit time of the actual transient torque of the rear wheel 3 is decreased. Therefore, when the vehicle body is inclined, the increase rate per unit time of the target torque is set small. Therefore, when the inclination of the vehicle body is detected, the increase per unit time of the set target torque is smaller than that when the inclination of the vehicle body is not detected. The target torque before the boost input device 10c is pressed by the rider is T4, and the target torque when the boost input device 10c is pressed by the rider and the rear wheel 3 is driven by the boost torque is T5.

In FIG. 11, the transition of the target torque when the straddle type vehicle 1 is not inclined is defined as L7, and the transition of the target torque when the straddle type vehicle 1 is inclined is defined as L8. In the present embodiment, when the straddle type vehicle 1 is inclined, in order to decrease the increase rate per unit time of the transient torque in the actual torque change, the target torque is set such that the driving torque increases more gently in the setting of the target torque. Specifically, when the straddle type vehicle 1 is not inclined, the target torque is set such that, at the time t1, the target torque becomes the torque T5 corresponding to the torque obtained by adding the boost torque to the normal torque from the torque T4 corresponding to the normal torque. After the time t1, the driving torque of the rear wheel 3 is constant at the torque T5. When the straddle type vehicle 1 is inclined, the target torque gradually increases such that the actual driving torque increases more gently than the transition L7. A time at which the target torque gradually increases and reaches the torque T5 when the straddle type vehicle 1 is inclined is defined as a time t5. After the target torque becomes the torque T5 at the time t5, the target torque is constant at T5. In the present embodiment, between the time t1 and the time t5, the target torque is set to increase by a constant amount at regular time intervals.

As illustrated in FIG. 11, at a time before the time t1 at which the boost input device 10c is pressed, the target torque of the engine E is T4, and the target torque of the drive motor M is 0. The target torque of the engine E on and after the time t1 is defined as Te2. The target torque of the drive motor M when the straddle type vehicle 1 is not inclined on and after the time t1 is defined as Tm3. The target torque of the drive motor M when the straddle type vehicle 1 is inclined is defined as Tm4.

The total target torque when the straddle type vehicle 1 is not inclined on and after the time t1 is T5 which is the total of the target torque Te2 of the engine E and the target torque Tm3 of the drive motor M, and the transition is L7. The total target torque when the straddle type vehicle 1 is inclined on and after the time t1 is the total of the target torque Te2 of the engine E and the target torque Tm4 of the drive motor M, and the transition is L8. The target torque Tm4 of the drive motor M is gradually increased by a constant amount at regular time intervals on and after the time t1, so that the transition L8 of the target torque increases gradually. As a result, if the straddle type vehicle 1 is not inclined when the boost input device 10c is pressed by the rider and the boost signal is received by the ECU 21, the target torque is instantaneously set to T5 at the time t1. When the boost input device 10c is pressed by the rider and the boost signal is received by the ECU 21, if the straddle type vehicle 1 is inclined, the target torque gradually increases until the time t5, and the target torque is maintained at T5 after the target torque reaches T5.

In the present embodiment, as illustrated in FIG. 11, when the straddle type vehicle 1 is not inclined, the target torque is set such that the target torque instantaneously reaches T5 at the time t1 (L7). On the other hand, when the straddle type vehicle 1 is inclined, the target torque is set such that the target torque reaches T5 by increasing by a certain amount at regular time intervals in the period between t1 and t5 (L8). As a result, when the straddle type vehicle 1 is inclined, the target torque is set to increase more gently than when the straddle type vehicle 1 is not inclined.

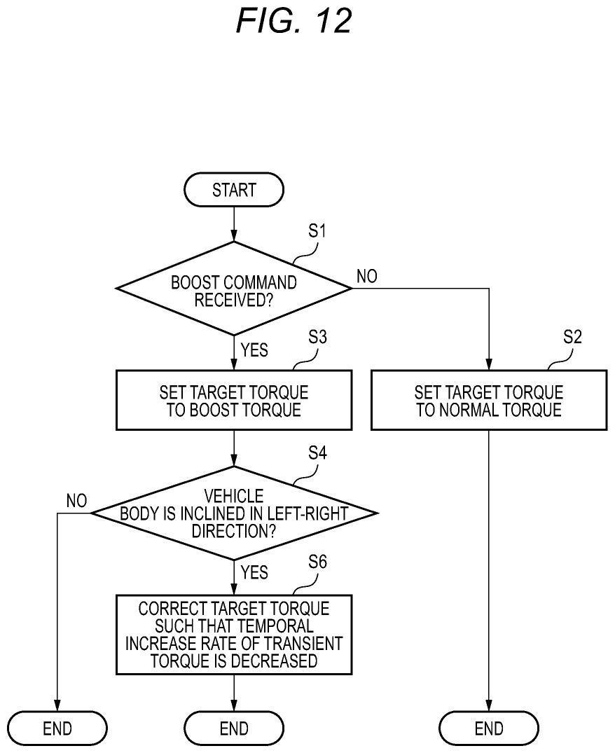

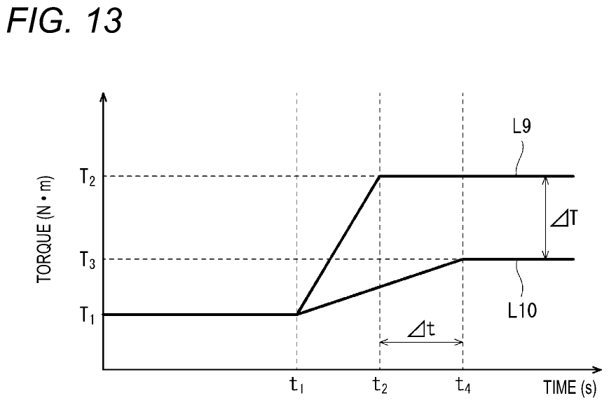

Next, a method for controlling the straddle type vehicle 1 according to the present embodiment will be described with reference to the flowchart of FIG. 12. Steps S1 to S4 in FIG. 12 are the same as those in FIG. 9. In S6, when it is detected that the vehicle body of the straddle type vehicle 1 is inclined in the left-right direction, the target torque is corrected such that the increase rate per unit time of the transient torque is decreased as compared with the state in which the target torque is transitioned from the normal torque to the boost torque in the normal state (normal transition state). In the present embodiment, when the inclination of the straddle type vehicle 1 is detected, the transition of the target torque is corrected from L7 to L8 by decreasing the increase rate per unit time of the target torque. When it is not detected that the vehicle body of the straddle type vehicle 1 is inclined in the left-right direction, the target torque is set such that the transition of the target torque becomes L7 and the torque rises in the normal transition state. In the present embodiment, in the setting of the target torque when the inclination of the vehicle body is detected, the transition of the target torque is made constant regardless of the degree of inclination, so that the time taken for the torque change when the inclination of the vehicle body is detected (t1 to t4) is made constant regardless of the degree of inclination.

The above embodiment has described an aspect in FIG. 10 in which the time taken for the torque change when the inclination of the vehicle body is detected (t1 to t4) is constant regardless of the degree of inclination, but the present invention is not limited to the above embodiment. The torque change of the rear wheel 3 may be controlled such that the time taken for the torque change when the inclination of the vehicle body is detected (t1 to t4) changes in accordance with the degree of inclination of the vehicle body when the boost signal is input to the ECU 21 by the rider pressing the boost input device 10c.

The gyroscope 5 may be capable of detecting the inclination angle of the vehicle body, and the driving torque control of the rear wheel 3 may be performed to increase the decreasing correction amount of the increase rate per unit time of the transient torque of the rear wheel 3 in the inclination transition state as the inclination angle of the vehicle body detected by the gyroscope 5 increases. Since the decreasing correction amount of the increase rate per unit time of the transient torque of the rear wheel 3 in the inclination transition state is increased as the inclination angle of the vehicle body increases, the increase rate per unit time of the transient torque of the rear wheel 3 decreases as the inclination angle of the vehicle body increases. Therefore, as compared to the line L5 indicating the change of the driving torque for driving the rear wheel 3 in the case where the inclination of the vehicle body is not present in FIG. 10, the slope of the line indicating the change of the driving torque for driving the rear wheel 3 becomes smaller as the inclination angle of the vehicle body increases. As a result, the time t4 until the driving torque of the rear wheel 3 reaches the boost torque T2 is delayed as the inclination angle of the vehicle body increases.

The slope of the line indicating the change of the driving torque of the rear wheel 3 is decreased as the inclination angle of the vehicle body increases, so that the torque change per unit time is decreased. In general, when the inclination angle of the vehicle body increases, the ride by the rider is easily affected by the torque change according to the magnitude of the inclination angle. In the present embodiment, since the torque change per unit time is decreased as the inclination angle of the vehicle body increases, it is possible to limit the influence of the torque change on the ride by the rider even when the inclination angle is large. Thus, the rider can ride the vehicle comfortably without being much affected by the torque change even when the inclination angle is large.

In addition, since the time required for the torque change changes in accordance with the degree of inclination of the vehicle body, the length of the time difference Δt in FIG. 10 changes. That is, the time difference Δt between the time t2 at which the driving torque of the rear wheel 3 when the vehicle body is not inclined reaches the boost torque T2 and the time t4 at which the driving torque of the rear wheel 3 when the vehicle body is inclined reaches the boost torque T2 is lengthened as the degree of inclination of the vehicle body increases. When the degree of inclination of the vehicle body is large, the time required for the driving torque of the rear wheel 3 to change from the normal torque T1 to the boost torque T2 is lengthened correspondingly. Therefore, the rider can obtain a larger time margin from the time when the boost input device 10c is pressed to the time when the driving torque of the rear wheel 3 reaches the boost torque T2.

In general, when the degree of inclination of the vehicle body increases, the time required to return the posture of the vehicle body from the inclined state to the upright state is lengthened. Therefore, when the boost command is input to the ECU 21 in a state in which the vehicle body is inclined, if the degree of inclination of the vehicle body is large, a long time may be required for the rider to take measures such as returning the vehicle body. In the present embodiment, when the degree of inclination of the vehicle body is large, the time required for the driving torque of the rear wheel 3 to change from the normal torque T1 to the boost torque T2 is lengthened in accordance with the degree of inclination. Therefore, the rider can take measures such as returning the vehicle body more securely. Therefore, the rider can ride the vehicle more comfortably.

When the decreasing correction amount of the increase rate per unit time of the transient torque of the rear wheel 3 in the inclination transition state is increased as the inclination angle of the vehicle body increases, the correction of the target torque such that the increase rate per unit time of the transient torque is decreased, which is performed in S5 of the flowchart of FIG. 12, may include increasing the decreasing correction amount of the increase rate per unit time of the transient torque of the rear wheel 3 as the inclination angle of the straddle type vehicle 1 increases. The target torque may be set such that the slope of the line L6 indicating the change of the driving torque illustrated in FIG. 10 decreases as the time required for the torque change is lengthened. At this time, in the setting of the target torque in FIG. 11, the difference between the time t1 and the time t5 may be set longer to make the transition L8 of the target torque gentler, thereby increasing the decreasing correction amount of the increase rate per unit time of the target torque. That is, the target torque may be set such that the time t5 at which the target torque reaches T5 after the boost input device 10c is pressed at the time t1 is further away from the time t1, thereby further delaying the time t5. As a result, the target torque may be set such that the decreasing correction amount of the increase rate per unit time of the transition L8 of the target torque is increased as the inclination angle of the straddle type vehicle 1 increases at the time of setting the target torque, thereby increasing the actual decreasing correction amount of the increase rate per unit time of the transient torque of the rear wheel 3.

According to the above embodiment, the target torque in the inclination transition state is corrected such that the increase rate per unit time of the transient torque of the drive wheel 3 in the inclination transition state is decreased more than the increase rate per unit time of the transient torque of the drive wheel 3 in the normal transition state. Therefore, the torque change of the straddle type vehicle can be limited when in the inclined state, in which the vehicle is likely to be affected by the torque change. Therefore, it is possible to limit a decrease in operability when the vehicle body is inclined.

Further, since the torque control of the drive wheel 3 is performed such that the decreasing correction amount of the increase rate per unit time of the transient torque of the drive wheel in the inclination transition state is increased as the inclination angle of the vehicle body increases, the increase rate per unit time of the transient torque of the rear wheel 3 is corrected to obtain the torque corresponding to the inclination angle of the vehicle body. Therefore, when the vehicle body is largely inclined, the torque change of the rear wheel 3 becomes gentler, and the operability can be further improved.

In the first embodiment, the torque control of the rear wheel 3 is performed such that the boost amount for the target torque decreases when the inclination of the vehicle body is detected. In the second embodiment, the torque control of the rear wheel 3 is performed such that the torque change per unit time decreases when the inclination of the vehicle body is detected. The torque control of the rear wheel 3 in the first embodiment and the torque control of the rear wheel 3 in the second embodiment may be performed at the same time.

FIG. 13 is a graph illustrating the correlation between the driving torque of the rear wheel 3 and the time in a case where the torque control of decreasing the boost amount for the target torque when the inclination of the vehicle body is detected and the torque control of decreasing the torque change per unit time when the inclination of the vehicle body is detected are performed simultaneously. The transition of the torque when the inclination of the vehicle body is not detected is indicated by a line L9, and the transition of the torque when the inclination of the vehicle body is detected is indicated by a line L10.

As indicated by the line L9 in FIG. 13, when the inclination of the vehicle body is not detected, if the boost command is input to the ECU 21 at the time t1, the driving torque transitions from the normal torque T1 to the boost torque T2. The time at which the correction of the boost torque is completed is the time t2, which is obtained by adding the time until the driving torque of the rear wheel 3 reaches the boost torque T2 when the vehicle body is in the upright state to the time t1 at which the boost input device 10c is pressed by the rider. On the other hand, as indicated by a line L10 in FIG. 13, when the inclination of the vehicle body is detected, the driving torque of the rear wheel 3 is the torque T3, which is corrected to decrease from the boost torque T2 by ΔT. The time at which the correction of the boost torque is completed is the time t4, which is obtained by adding a time such that the time t2 at which the correction of the boost torque is completed when the vehicle body is not inclined is delayed by Δt, by decreasing the increase rate per unit time of the transient torque (L10) of the drive wheel when the vehicle body is inclined to be lower than the increase rate per unit time of the transient torque (L9) of the drive wheel when the vehicle body is not inclined.

As illustrated in FIG. 13, when the inclination of the vehicle body is detected, the driving torque of the rear wheel 3 is corrected to decrease, and the time until the correction of the driving torque of the rear wheel 3 is completed is delayed. Thereby, the operation on the straddle type vehicle 1 can be prevented from being affected more securely even when the boost command is input when the vehicle body is inclined. Therefore, the rider can ride the vehicle comfortably.

### Other Embodiments

In the above embodiment, the gyroscope 5 is used as the posture detector for detecting whether the vehicle body is inclined and the inclination angle of the vehicle body, but the present invention is not limited to the above embodiment. Whether the vehicle body is inclined and the inclination angle may be detected by other configurations. For example, whether the vehicle body is inclined may be detected by detecting whether there is a difference between the rotation speed of the front wheel 2 and the rotation speed of the rear wheel 3. The inclination angle at which the vehicle body is inclined may be estimated by detecting the magnitude of the difference between the rotation speed of the front wheel 2 and the rotation speed of the rear wheel 3. When the vehicle body is in the upright state, the track of the front wheel 2 and the track of the rear wheel 3 are the same. Therefore, the rotation speed of the front wheel 2 and the rotation speed of the rear wheel 3 are the same. When the vehicle body is in an inclined state, the track of the front wheel 2 and the track of the rear wheel 3 are different from each other, and the front wheel 2 travels on a track outer than the rear wheel 3. Therefore, when the vehicle body is inclined, a difference occurs between the rotation speed of the front wheel 2 and the rotation speed of the rear wheel 3. Therefore, it is possible to detect whether the vehicle body is inclined by detecting the rotation speed of the front wheel 2 and the rotation speed of the rear wheel 3 and detecting whether there is a difference between the rotation speed of the front wheel 2 and the rotation speed of the rear wheel 3. Further, the inclination angle of the vehicle body can be estimated by detecting the difference between the rotation speed of the front wheel 2 and the rotation speed of the rear wheel 3.

Since the inclination of the vehicle body is detected based on the difference between the rotation speed of the rear wheel 3 and the rotation speed of the front wheel 2, an additional configuration for detecting the inclination, such as a gyroscope, is not necessary. Therefore, the configuration of the straddle type vehicle 1 can be simplified.

Further, the above embodiment has described a mode of performing the torque control of the straddle type vehicle 1, and has particularly described a mode of performing the torque control of a motorcycle, but the present invention is not limited to the above embodiment. For example, the present disclosure may be applied to a four-wheeled passenger vehicle. In this case, a gyroscope may be provided in the vehicle, and the inclination state of the vehicle may be detected by the gyroscope, or the inclination state of the vehicle may be detected by the tire force acting on the tire. The inclination of the vehicle may be detected not only in the left-right direction but also in the front-rear direction. The torque control of the drive wheel may be performed as long as the tire force acting on the tire falls within the friction limit of the tire when the boost command is input to the vehicle by the rider in a state where the vehicle is inclined. At this time, torque control may be performed to correct the driving torque for the drive wheel such that the tire force falls within the friction limit of the tire as a result of the tire force acting on the tire in the front-rear direction. That is, the torque control of the drive wheel may be performed to obtain a driving torque such that the tire of the drive wheel does not idle when the boost amount is added to the driving torque by the boost command from the rider.

Further, the tire force acting on the tire may be detected, and the torque control for the drive wheel may be performed such that the detected tire force does not exceed the friction limit of the tire. At this time, the torque control to the drive wheel may be performed such that the detected tire force does not exceed the friction limit of the tire when the driving torque to the drive wheel is added by the boost command, regardless of whether the vehicle is inclined.

In a case where the torque control of the drive wheel is performed based on the tire force, a margin for allowing the boost when the boost command is input to the ECU 21 may be determined based on the tire force. In a case where the margin is to be determined, when the tire force is detected, the tire force may be detected based on the bank angle β, the vehicle speed, the turning radius, the acceleration, and the like when the boost command is input to the ECU 21, and the margin for the tire force for allowing the boost may be determined from the detected tire force. The margin may be the difference between the tire force acting on the tire and the friction limit of the tire. When the boost command is input to the ECU 21 and the boost amount is added to the driving torque of the rear wheel 3, the margin may be a value indicating a margin regarding the magnitude of the tire force that can be added to the tire of the rear wheel 3. When the margin for the tire force of the rear wheel 3 is to be determined, a boost amount that can be boosted for the torque for driving the rear wheel 3 may be calculated. The torque control may be performed such that the maximum boost is performed within the range of the friction limit of the tire by adding the torque corresponding to the calculated boost amount to the driving torque of the rear wheel 3.

When the tire force is to be acquired, the tire force may be a directly detected value. In this case, as disclosed in JP-A-2017-161395, a strain gauge may be attached to a tire or a wheel, and the tire force acting on the tire may be directly detected by the strain gauge. When the tire force acting on the tire is to be detected, the torque control of the rear wheel 3 may be performed such that the tire force detected when the boost amount is added to the driving torque of the rear wheel 3 falls within the friction circle C1. When the torque control of the drive wheel is performed based on the tire force, the value of the tire force acting on the tire directly detected by the strain gauge may not be used as the tire force. A value related to the tire force may be detected, and the torque control of the drive wheel may be performed based on the value related to the tire force. The value related to the tire force includes, for example, an indirectly detected value of the force such as the frictional resistance between the road surface and the tire, the longitudinal force component of the tire force, the lateral force component of the tire force, and the total value of the longitudinal force component and the lateral force component of the tire force. The value related to the tire force includes a value correlated with the tire force, such as the inclination angle β of the vehicle body, the centrifugal force, and the combination of the vehicle speed and the rotation radius.

As described above, the vehicle may be a four-wheeled passenger car, but in order to sufficiently obtain the effect of the present embodiment, the vehicle is preferably a straddle type vehicle, and more preferably a motorcycle. The motorcycle has a smaller weight, and thus has a smaller friction limit of the tire is small and a larger power-weight ratio. Therefore, the acceleration thereof when the boost command is input to the ECU is larger. Therefore, when the rear wheel 3 is driven by the boost torque obtained by adding the boost amount to the normal torque, the addition of the boost amount to the driving torque may greatly affect the ride. According to the present embodiment, the torque correction is performed such that the boost amount added to the normal torque is decreased or the increase rate per unit time of the transient torque with respect to the driving torque of the rear wheel 3 is decreased when the vehicle is a motorcycle. Therefore, the decreasing correction on the boost amount for the torque or the decreasing correction on the increase rate per unit time of the transient torque can be performed even on a motorcycle, which has a small weight and a large power-weight ratio, and the rider can ride the vehicle comfortably.

The above embodiment has described an aspect in which the straddle type vehicle 1 is a hybrid vehicle including the engine E and the drive motor M as drive sources, and the engine E outputs the drive corresponding to the normal torque, and the drive motor M outputs the drive corresponding to the torque of the boost amount added to the normal torque when the boost command is input to the ECU 21. However, the straddle type vehicle 1 may not be a hybrid vehicle. The torque corresponding to the normal torque during the normal traveling may be driven by the engine E, and the torque corresponding to the boost amount when the boost command is input to the ECU 21 may be also driven by the engine E. In this case, the straddle type vehicle 1 may be configured such that the rear wheel 3 is driven only by the engine E. Alternatively, the torque corresponding to the normal torque during the normal traveling may be driven by the drive motor M, and the torque corresponding to the boost amount when the boost command is input to the ECU 21 may be also driven by the drive motor M. In this case, the straddle type vehicle 1 may be configured such that the rear wheel 3 is driven only by the drive motor M.

The above embodiment has described an aspect in which, when the inclination of the vehicle body is detected when the boost command is input to the ECU 21, the boost amount added to the normal torque T1 is corrected, and the torque T3 added with the boost amount is between the normal torque T1 and the boost torque T2 (FIG. 7). However, the torque T3 after the boost amount added to the normal torque T1 is corrected is not limited to the range between the normal torque T1 and the boost torque T2. When the inclination of the vehicle body is detected when the boost command is input to the ECU 21, the driving torque of the rear wheel 3 may be controlled in some cases such that the driving torque of the rear wheel 3 becomes a torque having a magnitude lower than that of the normal torque T1. When the boost amount is corrected, the boost amount may be corrected such that not only the driving torque of the rear wheel 3 generated by the drive motor M but also the driving torque of the rear wheel 3 generated by the engine E are decreased.

The above embodiment has described an aspect in which the engine E outputs the drive corresponding to the normal torque, and the drive motor M outputs the drive corresponding to the torque of the boost amount added to the normal torque when the boost command is input to the ECU 21. However, the drive of the engine E and the drive of the drive motor M may be reversed. That is, the drive motor M may output the drive corresponding to the normal torque, and the engine E may output the drive corresponding to the torque of the boost amount added to the normal torque when the boost command is input to the ECU 21. In the case where the drive motor M outputs the drive corresponding to the normal torque and the engine E outputs the drive corresponding to the torque of the boost amount, the driving torque of the rear wheel 3 may also be controlled such that the driving torque of the rear wheel 3 becomes a torque having a magnitude smaller than the normal torque T1 when the inclination of the vehicle body is detected when the boost command is input to the ECU 21.

The above embodiment has described an aspect in which the rider presses the boost input device 10c when the boost command is to be input to the ECU 21, but the present invention is not limited to the above embodiment. The rider may input the boost command to the straddle type vehicle 1 by another method when the boost command is to be input to the ECU 21. For example, an operator for operating with a foot may be provided around the footrest of the straddle type vehicle 1, and a boost command may be input to the ECU 21 by performing an input operation with the foot. In addition, a microphone may be provided inside the helmet, and the boost command may be input to the ECU 21 by the rider inputting a boost command to the microphone by voice.

The functions of the elements disclosed in the present specification can be executed using a circuit or a processing circuit that includes a general-purpose processor, a dedicated processor, an integrated circuit, an application specific integrated circuit (ASIC), a circuit in the related art, and/or a combination of the above elements and is implemented or programmed to execute the disclosed functions. Since the processor includes a transistor and other circuits, the processor is regarded as a processing circuit or a circuit. In the present disclosure, a circuit, a unit, or a means is hardware that executes the listed functions or hardware that is programmed to execute the listed functions. The hardware may be hardware disclosed in the present specification, or may be other known hardware that is programed to or configured to execute the listed functions. When the hardware is a processor considered to be a kind of a circuit, the circuit, the means, or the unit is a combination of hardware and software, and the software is used for implementing the hardware and/or the processor.

As described above, the embodiments have been described as examples of the technique disclosed in the present application. However, the technique in the present disclosure is not limited thereto, and is also applicable to embodiments in which modifications, replacements, additions, omissions, and the like are appropriately made. Further, it is also possible to combine the components described in the embodiments described above to construct a new embodiment. For example, a part of configurations or a method in one embodiment may be applied to another embodiment, and a part of configurations in an embodiment can be freely extracted separately from the other configurations in the embodiment. In addition, the constituent elements described in the accompanying drawings and the detailed description include not only constituent elements essential for solving the problem but also constituent elements that are not essential for solving the problem in order to illustrate the technique.

This application is based on and claims priority under 35 USC 119 from Japanese Patent Application No. 2021-188372 filed on Nov. 19, 2021, the contents of which are incorporated herein by reference.

What is claimed is:

1. A straddle type vehicle comprising:
a drive wheel;
a vehicle body supported by the drive wheel;
at least one traveling drive source configured to generate a torque to be transmitted to the drive wheel;
a posture detector configured to detect a posture of the vehicle body;
a boost input device configured to accept a boost command; and
a processing circuit configured to control the at least one traveling drive source, wherein
the processing circuit is configured to:
determine a target torque of the traveling drive source as a normal torque in accordance with a predetermined travel rule when the boost command is not given to the boost input device;
change, upon receiving a boost signal from the boost input device, the target torque from the normal torque to a boost torque obtained by adding a predetermined boost amount to the normal torque; and
correct, upon receiving a predetermined inclination signal from the posture detector, the target torque such that a torque change of the drive wheel when the target torque is changed from the normal torque to the boost torque is decreased as compared with a case where the inclination signal is not received.

2. The straddle type vehicle according to claim 1, wherein
the correction of the target torque includes correcting to decrease the boost amount.

3. The straddle type vehicle according to claim 1, wherein
the posture detector detects an inclination angle of the vehicle body, and
the correction of the target torque includes correcting the target torque such that a decrease amount of the torque change of the drive wheel is increased as the inclination angle detected by the posture detector increases.

4. The straddle type vehicle according to claim 1, further comprising:
a transmission disposed in a power transmission path from the traveling drive source to the drive wheel; and
a transmission sensor configured to detect a gear ratio of the transmission, wherein
the correction of the target torque includes correcting the target torque such that a decrease amount of the torque change of the drive wheel is increased as the gear ratio detected by the transmission sensor increases.

5. The straddle type vehicle according to claim 1, wherein
when the boost command is continuously input, the boost input device continuously transmits the boost signal to the processing circuit, and in the correction of the target torque, the processing circuit continuously corrects the target torque in accordance with a latest inclination signal received from the posture detector during a period in which the boost signal is continuously received from the boost input device.

6. The straddle type vehicle according to claim 1, wherein
the at least one traveling drive source includes a first traveling drive source and a second traveling drive source,
the processing circuit is configured to further determine torque distribution between the first traveling drive source and the second traveling drive source in accordance with the target torque, and
the determination of the torque distribution includes determining the torque distribution such that the second traveling drive source generates a drive force corresponding to the boost amount.

7. The straddle type vehicle according to claim 1, wherein
a state in which the predetermined inclination signal is not received from the posture detector and the target torque is transitioned from the normal torque to the boost torque is defined as a normal transition state,
a state in which the predetermined inclination signal is received from the posture detector and the target torque is transitioned from the normal torque to the boost torque is defined as an inclination transition state, and
the correction of the target torque includes correcting the target torque in the inclination transition state such that an increase rate per unit time of a transient torque of the drive wheel in the inclination transition state is decreased relative to an increase rate per unit time of the transient torque of the drive wheel in the normal transition state.

8. The straddle type vehicle according to claim 7, wherein
the posture detector detects an inclination angle of the vehicle body, and
the correction of the target torque includes increasing a decreasing correction amount of the increase rate per unit time of the transient torque of the drive wheel in the inclination transition state as the inclination angle of the vehicle body detected by the posture detector increases.

9. The straddle type vehicle according to claim 1, further comprising:
a driven wheel, wherein
the posture detector detects that the vehicle body is inclined based on a difference between a rotation speed of the drive wheel and a rotation speed of the driven wheel.

10. A method for controlling a vehicle including: a drive wheel; a vehicle body supported by the drive wheel; at least one traveling drive source configured to generate a torque to be transmitted to the drive wheel; a detector configured to detect a value related to a tire force generated on a wheel with respect to a road surface during travel; and a boost input device configured to accept a boost command, the method comprising:
determining a target torque of the traveling drive source as a normal torque in accordance with a predetermined travel rule when the boost command is not given to the boost input device;
changing, upon receiving a boost signal from the boost input device, the target torque from the normal torque to a boost torque obtained by adding a predetermined boost amount to the normal torque; and
correcting, based on a value related to the tire force detected by the detector, the target torque when changing the target torque from the normal torque to the boost torque.

11. A non-transitory computer readable storage medium storing a control program configured to cause at least one processor to execute the method for controlling the vehicle according to claim 10.
